(19) United States
(12) Patent Application Publication
(10) Pub. No.: US 2026/0017554 A1
(43) Pub. Date: Jan. 15, 2026

(54) CROSS ARCHITECTURAL QUANTUM CIRCUIT COMPILER

(71) Applicant: Red Hat, Inc., Raleigh, NC (US)

(72) Inventors: Leigh Griffin, Waterford (IE); Stephen Coady, Dublin (IE)

(21) Appl. No.: 18/768,894

(22) Filed: Jul. 10, 2024

(51) Int. Cl. G06N 10/60; G06N 10/20; G06N 10/40

(52) U.S. Cl. CPC G06N 10/60; G06N 10/20; G06N 10/40

(57) ABSTRACT

Systems and methods for cross-architectural compilation of quantum computing programs are provided. A computing system comprising one or more computing devices can obtain first quantum architecture data indicative of a first quantum computing architecture shared by a first plurality of quantum computers, wherein the first quantum computing architecture comprises a first quantum instruction set architecture. The computing system can obtain quantum operations data indicative of a plurality of quantum computing operations, wherein the quantum computing operations comprise at least one operation that is not specific to the first quantum computing architecture. The computing system can map, based on the first quantum architecture data, the at least one operation to one or more corresponding architecture-specific operations associated with the first quantum computing architecture. The computing system can compile, based at least in part on the mapping, one or more computer-readable instructions for performing a quantum algorithm comprising the architecture-specific operations.

### BACKGROUND

Quantum computing is a method for using quantum mechanical properties of physical systems to perform computations. Quantum computing uses quantum bits, referred to herein as “qubits,” each of which has quantum mechanical properties that may differ from non-quantum bits used in classical computing. For example, a quantum state of a quantum bit can include a superposition of two or more basis states, such as |0 [symbol] and |1 [symbol] , which can be analogous to the binary states 0 and 1 of a classical computer. As another example, a quantum state of two or more quantum bits can become entangled, such that the states of the two or more quantum bits are correlated.

### SUMMARY

The present disclosure is generally directed to systems and methods for enabling write-once-compile-anywhere operation of quantum computing programs. For example, a computing system can receive a quantum computing program (e.g., from a user) and can compile the quantum computing program to execute on any one of multiple quantum computing architectures (e.g., IBM architecture, Rigetti architecture, Google Sycamore architecture, etc.).

In one implementation, a method is provided. The method includes obtaining, by a computing system comprising one or more computing devices, first quantum architecture data indicative of a first quantum computing architecture shared by a first plurality of quantum computers, wherein the first quantum computing architecture comprises a first quantum instruction set architecture. The method further includes obtaining, by the computing system, quantum operations data indicative of a plurality of quantum computing operations, wherein the quantum computing operations comprise at least one operation that is not specific to the first quantum computing architecture. The method further includes mapping, by the computing system based on the first quantum architecture data, the at least one operation to one or more corresponding architecture-specific operations associated with the first quantum computing architecture. The method further includes compiling, by the computing system based at least in part on the mapping, one or more computer-readable instructions for performing a quantum algorithm comprising the one or more corresponding architecture-specific operations

In another implementation, a computing system is provided. The computing system includes one or more computing devices. The one or more computing devices are to obtain first quantum architecture data indicative of a first quantum computing architecture shared by a first plurality of quantum computers, wherein the first quantum computing architecture comprises a first quantum instruction set architecture. The one or more computing devices are further to obtain quantum operations data indicative of a plurality of quantum computing operations, wherein the quantum computing operations comprise at least one operation that is not specific to the first quantum computing architecture. The one or more computing devices are further to map, based on the first quantum architecture data, the at least one operation to one or more corresponding architecture-specific operations associated with the first quantum computing architecture. The one or more computing devices are further to compile, based at least in part on the mapping, one or more computer-readable instructions for performing a quantum algorithm comprising the one or more corresponding architecture-specific operations.

In another implementation, a non-transitory computer-readable storage medium is provided. The non-transitory computer-readable storage medium includes executable instructions to cause one or more processor devices to obtain first quantum architecture data indicative of a first quantum computing architecture shared by a first plurality of quantum computers, wherein the first quantum computing architecture comprises a first quantum instruction set architecture. The instructions further cause the one or more processor devices to obtain quantum operations data indicative of a plurality of quantum computing operations, wherein the quantum computing operations comprise at least one operation that is not specific to the first quantum computing architecture. The instructions further cause the one or more processor devices to map, based on the first quantum architecture data, the at least one operation to one or more corresponding architecture-specific operations associated with the first quantum computing architecture. The instructions further cause the one or more processor devices to compile, based at least in part on the mapping, one or more computer-readable instructions for performing a quantum algorithm comprising the one or more corresponding architecture-specific operations.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which examples disclosed herein may be practiced;

FIG. 2 is a flowchart diagram of a method for compiling a quantum computing program to a first quantum architecture;

FIG. 3 is a simplified block diagram of the environment illustrated in FIG. 1 according to one implementation; and

FIG. 4 is a block diagram of a computing device suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

As the field of quantum computing has grown, a variety of quantum computing providers have developed a variety of quantum computing architectures that may not be directly compatible with each other. As an illustrative example, a program written for a quantum computing architecture developed by IBM may be portable between a plurality of IBM quantum computing systems, but may be incompatible with a Rigetti or Google quantum computing system. For example, some quantum computing architectures may include an instruction set architecture defining a set of instructions recognized by the quantum computing system. In some instances, an instruction recognized by a first quantum computing architecture may not be recognized by a second quantum computing architecture. In such instances, a program written for the second architecture may be incompatible with the first architecture. As another example, different quantum computing architectures may include different sets of hardware components; different hardware abstraction layers, such that similar hardware components are controlled or modelled differently in a quantum computing language or instruction set; different sets of supported quantum gate types; different qubit types; different operating systems or other control software; and other architectural differences.

These architectural differences and incompatibilities can pose a challenge to quantum programmers or users who may wish to develop a quantum computing program that can execute across multiple quantum computing architectures. For example, according to some alternative methods, writing a quantum computing program for four quantum computing architectures may require writing, testing, and debugging four separate programs that may operate according to different logic. As an illustrative example, some quantum computing programs may involve one or more higher-level operations that can be built from lower-level quantum operations (e.g., multi-qubit arithmetic operations built from one-, two-and three-qubit quantum logic gates, etc.). However, different architectures may support different sets of lower-level operations, such as different universal sets of quantum gates. A universal set of quantum gates is a set of gates that can be mixed and matched to modularly build any possible quantum algorithm. However, a quantum operation built from a first universal set of quantum gates (e.g., Pauli X/Y/Z rotations+phase shift+controlled-not) may have a very different logic from the same quantum operation built from a second universal set of quantum gates (e.g., Clifford set+T gate, Toffoli gate+Hadamard gate, etc.), such that a quantum program may need to be rewritten from scratch for the second universal set. The same can be true for higher-level quantum instruction set architectures, hardware abstraction layers, and the like.

The examples set forth below provide various means for enabling cross-architectural use of a quantum computing program (e.g., “write-once-run-anywhere” operation). For example, the examples set forth below include example cross-architectural compilers that can receive a quantum computing program written for a first architecture (or written in an abstract language that does not correspond to any architecture) and can compile the quantum computing program to a second architecture, which may recognize a different instruction set from the first architecture; different hardware components or hardware abstraction layer components; different operating systems or other control software; or other differences. For example, in some implementations, a cross-architectural quantum compiler can access a data structure (e.g., database, etc.) correlating various commands or combinations of commands from a first instruction set architecture to corresponding commands or combinations of commands from a second instruction set architecture; map, based on data received from the data structure, the operations of the first-architecture quantum computing program to corresponding second-architecture operations; and compile, based on the mapping, a compiled second-architecture quantum program. As a non-limiting illustrative example, a cross-architectural compiler may recognize, in a first program, a combination of lower-level instructions (e.g., Toffoli and Hadamard gates, etc.) that correspond to a higher-level operation (e.g., arithmetic operations, etc.) when combined. The cross-architectural compiler may then map, based on data retrieved from the data structure, the higher-level operation to a combination of lower-level operations (e.g., rotations, phase shifts, and controlled-not operations, etc.) of a second instruction set that correspond to the same higher-level operation when combined. As another illustrative example, a first architecture may include a higher-level operation in its instruction set architecture, wherein one first-architecture operation may map to a plurality of corresponding second-architecture operations (or vice versa). Other examples are possible.

In addition to cross-architectural compilation of quantum computing programs, the examples set forth below provide a variety of additional features that may be useful for write-once-run-anywhere operation of a quantum computing program across multiple quantum computing architectures or devices. For example, some implementations can include compatibility checking, wherein a computing system can analyze a program and check whether it is compatible with a particular quantum computing architecture; quantum operating system; quantum computing device; or the like. As another example, some implementations can include cross-architectural optimization of quantum computing algorithms, such as optimizing operations for a particular instruction set (e.g., to minimize a number of instructions in the compiled program, etc.); hardware layout (e.g., to optimize a routing of a quantum signal for a particular hardware topology); hardware components (e.g., to minimize the number of quantum gates used by a compiled program, minimize the runtime of the compiled program, maximize computational accuracy, etc.); or the like.

The examples set forth below provide a variety of technical effects and benefits, such as improved interoperability of quantum computing programs and quantum computing architectures; reduced computational cost; and improved technical performance (e.g., accuracy, runtime, etc.) of compiled computing programs compared to some alternative methods. For example, the examples set forth below can provide improved interoperability by automatically compiling (e.g., without human intervention) a quantum computing program to two or more quantum computing architectures that may be incompatible with each other or with the program as originally written. As another example, the examples set forth below can in some instances provide improved technical performance (e.g., reduced runtime, improved accuracy, etc.) of a compiled program by automatically mapping operations that are not optimized for an architecture (e.g., incompatible operations, compatible operations that do not take advantage of architecture-specific optimization options, etc.) to corresponding operations that are optimized for the architecture. Similarly, the examples set forth below can in some instances provide reduced computational cost (e.g., electricity cost, hardware usage, hardware cost, etc.) compared to some alternative implementations by mapping operations that are not cost-optimized for an architecture to operations that are cost-optimized for the architecture.

Additionally, improved interoperability can provide a variety of additional technical benefits, such as reduced computational cost, improved technical performance, and the like. For example, in some instances, a quantum computer programmer may write a program for a first architecture without knowing in advance whether the first architecture is the most efficient (e.g., most accurate, lowest cost, etc.) architecture for executing the quantum program. In such instances, the examples set forth below can compile the quantum computing program to a plurality of architectures, and the compiled programs can be tested to compare the performance of the programs across architectures. The quantum program can then be executed on whichever architecture performs best. In this manner, for instance, a computational cost or technical performance of a single-architecture quantum computing program can be improved.

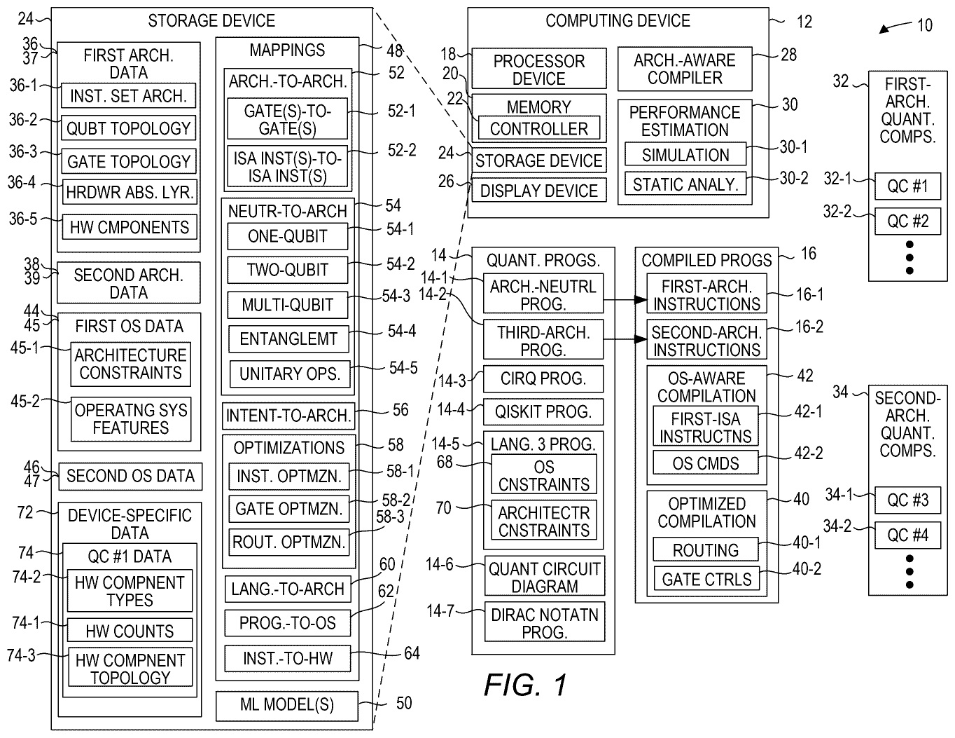

FIG. 1 is a block diagram of an environment in which examples disclosed herein can be practiced. A computing system 10 comprising one or more computing devices 12 can obtain one or more quantum computing programs 14, which may include architecture-neutral programs 14-1 or architecture-specific programs 14-2. The computing system 10 can compile the quantum computing programs 14 to generate one or more corresponding compiled programs 16, which can include architecture-specific compiled programs 16-1 and 16-2, which may be associated with a quantum computing architecture that is different from a quantum computing architecture of an architecture-specific quantum program 14-2.

A computing device 12 may comprise any computing or electronic device capable of including firmware, hardware, and/or executing software instructions to implement the functionality described herein, such as a computer server, a desktop computing device, a laptop computing device, a smartphone, a computing tablet, or the like. Each computing device 12 of a computing system 10 can include one or more processor devices 18, memories 20 comprising a memory controller 22, storage devices 24, or display devices 26. The computing device 12 can include one or more modules (e.g., software modules, firmware modules, hardware components, etc.) for performing specific tasks, such as an architecture-aware compiler 28 or one or more performance estimation modules 30, such as a simulation-based performance estimation module 30-1 or static-analysis-based performance estimation module 30-2.

A quantum program 14 can include, for example, any computer-readable data indicative of one or more quantum computing operations to be performed by a quantum computer, such as a first-architecture quantum computer 32 or second-architecture quantum computer 34. In some instances, a quantum program 14 can include an architecture-neutral quantum program 14-1 describing quantum operations in a manner that is not specific to any particular quantum computing architecture, or an architecture-specific quantum program 14-2 describing quantum operations specific to a third quantum computing architecture (e.g., instructions of a third quantum instruction set architecture, etc.) that may be different from a first or second quantum computing architecture 36, 38 associated with a quantum computing architecture of one or more quantum computers 32, 34 on which a user would like to execute the quantum computing operations.

In some instances, a quantum program 14 can include a plurality of computer-readable instructions in a quantum programming language, such as a Cirq program 14-3 written in the Cirq programming language, Qiskit program 14-4 written in the Qiskit programming language, or third-language program 14-5 written in another programming language (e.g., OpenQASM, Quipper, Q#, etc.). In some instances, a programming language can include a language that is specific to a particular architecture or an architecture-agnostic language that describes quantum operations without reference to any particular architecture. In some instances, a quantum program 14 can include a computer-readable description of quantum operations in a format that may not correspond to a quantum programming language, such as a quantum circuit diagram 14-6 (e.g., in a standardized file format or representation format, such as a Qiskit circuit diagram representation, etc.), a Dirac notation description 14-7 or matrix-notation description of one or more quantum operations. For example, in some instances, a Dirac notation description 14-7 can define a plurality of quantum operations using one or more matrices representing one or more of: an initial quantum state of one or more qubits; one or more unitary operator matrices describing a unitary transformation of a state of one or more qubits (e.g., unitary transformation to be implemented by one or more quantum gating operations, etc.); measurement operators describing a measurement to be performed on one or more qubits; or other aspect of a quantum algorithm.

A compiled program 16 can include a plurality of computer-readable instructions that, when executed by a quantum computer 32, 34, cause the quantum computer 32, 34 to perform operations, wherein the operations are equivalent to operations described in a quantum program 14 the compiled program 16 is based on. In some instances, the compiled program 16 can include a program that has been compiled for a specific quantum computing architecture 36, 38. For example, in some instances, a compiled program 16 can include a plurality of first-architecture instructions 16-1 that, when executed by a first-architecture quantum computer 32 characterized by a first quantum computing architecture 36, cause the first-architecture quantum computer 32 to perform the operations described in the quantum program 14, or equivalent operations (e.g., operations achieving a mathematically equivalent result, creating a physically equivalent quantum state, etc.). For example, in some instances, a compiled program 16-1 can include (e.g., consist of) a plurality of instructions belonging to an instruction set architecture 36-1 of the first quantum computing architecture. Similarly, in some instances, a compiled program can include a plurality of second-architecture instructions 16-2 that, when executed by a second-architecture quantum computer 34 characterized by a second quantum computing architecture 38, cause the second-architecture quantum computer 34 to perform the operations described in the quantum program 14. In some instances, a compiled program 16 can include an optimized compilation 40 comprising a plurality of computer-readable instructions that have been optimized to maximize a performance of the compiled program 16 on a particular quantum computing architecture 36, 38, or an OS-aware compilation 42 comprising one or more computer-readable instructions that may be tailored to a particular quantum operating system. In some instances, a compiled program 16 can include an intermediate program (e.g., quantum assembly language (QASM) program, etc.) configured to be further compiled by an architecture-specific compiler (e.g., to generate quantum machine code, generate or define control pulses, etc.) or device-specific compiler (e.g., to allocate specific qubits or other hardware components, to convert ISA instructions to hardware-level quantum gating operations, etc.).

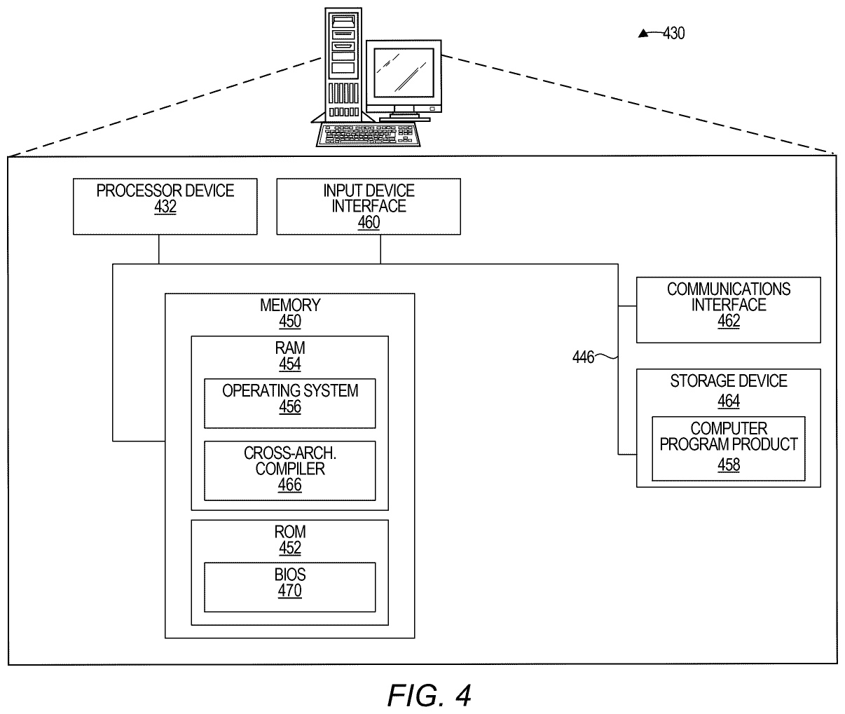

A processor 18, memory 20, memory controller 22, storage device 24, and display device 26 can include any device or component (e.g., computing component) to perform the functions of a processor, memory, memory controller, storage device, or display device. Further details of example components of an example computing system are provided below with respect to FIG. 4.

An architecture-aware compiler 28 or performance estimation module 30 can include one or more hardware, firmware or software components for performing architecture-aware compilation or performance estimation respectively. Because the architecture-aware compiler 28 and performance estimation module(s) 30 are components of the computing device 12, functionality implemented by the architecture-aware compiler 28 or performance estimation module(s) 30 may be attributed to the computing device 12 or computing system 10 generally. Moreover, in examples where the architecture-aware compiler 28 or performance estimation module(s) 30 comprises software instructions that program a processor device 18 to carry out functionality discussed herein, functionality implemented by the architecture-aware compiler 28 or performance estimation module 30 may be attributed herein to the processor device 18. It is further noted that while the architecture-aware compiler 28 and performance estimation module(s) 30 are shown as separate components, in other implementations, the architecture-aware compiler 28 and performance estimation module(s) 30 could be implemented in a single component or could be implemented in a greater number of components than three.

For example, in some instances, an architecture-aware compiler 28 or performance estimation module 30 can be a component of a quantum orchestration system configured to compile or deploy a quantum program 14 to a plurality of quantum computing architectures 36, 38. In some instances, a quantum orchestration system can be configured to compile or deploy to a plurality of architectures in response to a single command indicating which architectures a user would like to compile or deploy to. As another example, in some instances, an architecture-aware compiler 28 or performance estimation module 30 can be a component of a quantum infrastructure-as-code system. As used herein, infrastructure-as-code refers to systems (e.g. Red Hat Satellite, Ansible, etc.) and methods for managing (e.g., allocating, scheduling, configuring, etc.) infrastructure resources (e.g., quantum computing devices, quantum hardware such as qubit hardware, classical computing devices or components thereof, virtual resources such as virtual machines or containers, etc.) using machine-readable data (e.g., configuration files, definition files, computer code, etc.).

First-architecture quantum computers 32 can include, for example, a plurality of quantum computers that share a common first architecture 36. In some instances, each quantum computer of the plurality of first-architecture quantum computers 32 can have one or more shared properties that are shared between a plurality of first-architecture quantum computers 32 and one or more individual properties that may be unique or otherwise different from one or more other first-architecture quantum computers 32. As a non-limiting illustrative example, in some instances, a plurality of first-architecture quantum computers 32 may share a common instruction set architecture 36-1, topology 36-2 or 36-3, and hardware abstraction layer 36-4, while each individual first-architecture quantum computer 32 may have different numbers of hardware components (e.g., different numbers of qubits, gates, control lines, etc.) compared to other first-architecture quantum computers 32, or may have different types of hardware components (e.g., superconducting qubits vs. trapped ion qubits; fluxonium qubits vs. transmon qubits; etc.) compared to other first-architecture quantum computers 32.

Similarly, second-architecture quantum computers 34 can include a plurality of quantum computers that share a common second architecture 38. Each quantum computer of the plurality of second-architecture quantum computers 34 can have one or more shared properties that are shared between a plurality of second-architecture quantum computers 34 and one or more individual properties that may be unique or otherwise different from one or more other second-architecture quantum computers 34 (e.g., as described above with respect to first-architecture quantum computers 32).

A first-architecture quantum computer 32 or second-architecture quantum computer 34 can include a physical quantum computing device (e.g., superconducting quantum computer, trapped ion quantum computer, photonic quantum computer, quantum dot computer, neutral atom quantum computer, etc.) or a virtual quantum computing device (e.g., quantum container or quantum virtual machine executing on a quantum computing device, quantum computation simulator executed by a classical device, etc.) having the first or second architecture. A virtual quantum computing device can include, for example, an isolated environment executing on a physical quantum computing device, which may use only a subset of a physical quantum computing device's hardware components (e.g., qubits, control lines, gating hardware, etc.), which may be isolated (e.g., logically isolated, physically isolated, etc.) from the remaining hardware components of the physical quantum computing device.

In some instances, a computing device 12 can store data 37 indicative of a first quantum computing architecture 36 in a storage device 24. The data 37 can be stored in any appropriate data structure, such as a database, data table, file structure, folder structure, data object or data collection associated with an object-oriented programming language, or any other appropriate data structure. The data 37 can include data describing any aspect of a first quantum computing architecture, such as a quantum instruction set architecture 36-1, qubit topology 36-2, gate topology 36-3, hardware abstraction layer 36-4, hardware components 36-5 (e.g., data indicative of hardware component types supported by the first architecture 36, etc.), or other architecture data.

Similarly, a computing device 12 can store data 39 indicative of a second quantum computing architecture 38. The data 39 can have any property described herein with respect to data 37, and the second quantum computing architecture 38 can have any property described herein with respect to a first quantum computing architecture 36.

A first quantum computing architecture 36 can include, for example, any architecture that is shared by a plurality of quantum computing devices. As used herein, a quantum computing architecture refers to any aspect of a quantum computing device design that is shared between a plurality of quantum computing devices, including but not limited to an instruction set architecture 36-1; a microarchitecture for implementing an instruction set architecture; a hardware topology 36-2 or 36-3; a logic design; a hardware abstraction layer 36-4; hardware components or component types 36-5; a quantum operating system 44, 46, quantum basic input-output system (BIOS), or other quantum software or firmware that may be common to a plurality of quantum computing devices, such as basic control software; and the like.

A first quantum instruction set architecture 36-1 can be, for example, a set of instructions recognized by a plurality of first-architecture quantum computers 32. As used herein, an instruction set architecture refers to any set of computer-readable instructions recognized by a plurality of quantum computing devices sharing a quantum computing architecture, wherein the quantum computing devices are configured to execute quantum computing programs comprising instructions of the instruction set architecture. For example, instructions of an instruction set architecture can include a set of quantum assembly language instructions or quantum machine language instructions; a set of architecture-specific quantum programming language instructions; instructions of an application programming interface (API) or application binary interface (ABI) defining an interface for defining a quantum computing program; or the like. In some instances, a quantum instruction set architecture 36-1 can comprise one or more instructions that correspond to one or more quantum logic gates operating on one or more qubits; one or more instructions for initializing a qubit state; one or more instructions for measuring a qubit state; one or more instructions for allocating a qubit or requesting allocation of a qubit to the quantum program; and the like.

In some instances, an architecture-aware compiler can obtain a quantum program 14 that is not specific to a first architecture 36 and can compile a compiled program 16 for execution on first-architecture quantum computers 32. In some instances, the compiled program 16 can include one or more instructions of the first instruction set architecture 36-1 (first ISA).

Compiling a first-architecture compiled program 16-1 based on a quantum program 14 can include, for example, mapping each instruction or group of instructions of the quantum program 14 to equivalent instructions of the first architecture 36. Mapping can include, for example, deterministically mapping based on a mapping data structure 48 correlating quantum program 14 instructions to first-ISA 36-1 instructions; deterministically or non-deterministically mapping based on an optimization algorithm (e.g., heuristic algorithm, evolutionary algorithm, etc.); machine-learned mapping using a machine-learned model 50 (e.g., machine-learned model having one or more attention heads or attention layers), such as a machine-learned model 50 configured to receive all or part of a quantum program 14 as input and generate all or part of a compiled program 16 as output. Further details of example systems and methods for using a machine-learned model 50 to assist in optimizing a compiled program 16 are further provided below with respect to optimized compilations 40.

A mapping data structure 48 can include, for example, various kinds of mappings or mapping data structures, such as architecture-to-architecture mappings 52, neutral-to-architecture mappings 54, architecture-to-intent mappings 56, optimization mappings 58, language-to-architecture mappings 60, program-to-operating-system mappings 62, or instruction-to-hardware mappings 64.

For example, an architecture-to-architecture mapping 52 can include a plurality of data entries correlating one or more operations or components associated with a first quantum computing architecture 36 to one or more corresponding operations or components of another quantum computing architecture (e.g., second architecture 38, third architecture, etc.). This can include, for example, mapping from one operation of the first architecture 36 to a group of interrelated operations of the second architecture; a group of operations of the first architecture to one operation of the second architecture; one operation to one operation; or group-to-group mappings. Architecture-to-architecture mapping 52 can include mappings of various types of operations such as gate(s)-to-gate(s) mappings 52-1 correlating one or more quantum gates of the first architecture 36 to one or more quantum gates of another architecture; ISA-to-ISA mappings 52-2 correlating one or more instructions of a first quantum instruction set architecture 36-1 to another quantum instruction set architecture (ISA); or other mappings between operations or components, such as allocation-to-allocation mappings (e.g., qubit allocation mappings, etc.), hardware-to-hardware mappings, routing-to-routing mappings, or the like.

In some instances, a gate-to-gate mapping 52-1 data structures can include naive mappings correlating each type of quantum gate supported by a first architecture 36 (e.g., each quantum gate in a universal gate set of the first architecture 36) to groups of one or more quantum gates of a second architecture 38 and vice versa. For example, a second architecture 38 may comprise a universal quantum gate set supported by the second architecture 38, and the gate-to-gate mapping 52-1 can include instructions for emulating each quantum gate type of the first architecture 36 using one or more quantum gates of the second architecture 38. For example, in some instances, a gate-to-gate mapping 52-1 data entry can correlate a single quantum gate of a first-architecture universal gate set to a plurality of quantum gates of a second-architecture universal gate set. As a non-limiting illustrative example, a first architecture 36 may support a universal gate set comprising Toffoli gates and Hadamard gates, while a second architecture 38 may support a universal gate set comprising Pauli X, Y, and Z rotations, phase shift gates, and controlled not gates. In such instances, a gate-to-gate mapping can include a data entry describing how to emulate a Toffoli gate using one or more Pauli rotations, phase shifts, or controlled not operations; how to emulate a Hadamard gate using one or more Pauli rotations, phase shifts, or controlled not operations; how to emulate a Pauli X rotation using one or more Toffoli gates and Hadamard gates; and so on. Similarly, an ISA-to-ISA mapping can include naive mappings correlating each instruction of a first instruction set architecture 36-1 to corresponding groups of one or more second-architecture 38 ISA instructions, and vice versa. For example, in some instances, an ISA-to-ISA mapping 52-2 data entry can correlate a single instruction of a first instruction set architecture 36-1 to a plurality of instructions of a second quantum instruction set architecture. Although additional methods discussed below may provide more optimized (e.g., reduced circuit depth, fewer qubits required, faster runtimes, etc.) compiled programs 16 compared to using naive gate-to-gate mappings exclusively, naive gate-to-gate mappings 52-1 can in some instances provide universal or near-universal architecture-to-architecture coverage, such that each possible gate of a source architecture can be mapped to a corresponding group of gates or ISA instructions of a target architecture, thereby reducing a likelihood that a quantum program may fail to compile into the target architecture 36, 38. For example, in some instances, an architecture-aware compiler 28 may use optimized higher-level mappings wherever possible, and may use naive gate-to-gate or ISA-to-ISA mapping to fill in any gaps in a quantum program 14 that do not map to a higher-level optimized operation of a target architecture 36, 38.

In some instances, gate-to-gate and ISA-to-ISA mappings can also include group-to-group mappings that can map a plurality of gates of a first architecture to a corresponding plurality of gates of a second architecture, such as intent-to-architecture mappings 56 or optimized mappings 66. Further details of example data structures for optimized mappings are further described below with respect to optimized compiled programs 40.

Neutral-to-architecture mappings 54 can include, for example, data entries correlating architecture-agnostic descriptions of one or more quantum operations to corresponding architecture-specific groups of one or more operations of a target quantum architecture 36, 38. Additionally, neutral-to-architecture mappings 54 can include mappings from one or more operations of a quantum computing architecture 36, 38 to an architecture-agnostic description of quantum operations. An architecture-agnostic description can include, for example, a quantum program 14-3, 14-4, 14-5 in a quantum programming language that may be compatible with more than one quantum computing architecture; a quantum circuit diagram 14-6 or other visual depiction of one or more quantum operations; a description in mathematical notation of one or more quantum operations, such as a description using unitary matrix operators or a description in Dirac notation 14-7; or any other description of quantum operations that may be applicable to more than one quantum computing architecture.

Neutral-to-architecture mappings 54 can include, for example, mappings from one or more architecture-agnostic operations (e.g., architecture-agnostic quantum gating operations) to one or more architecture-specific operations (e.g., first-architecture 36 gating operations; first-ISA 36-1 instructions; etc.) and vice versa. This can include, for example, one-qubit quantum gate mappings 54-1, two-qubit quantum gate mappings 54-2, or multi-qubit quantum gate mappings 54-3. In some instances, a data structure can include entanglement-related data entries 54-4 correlating an architecture-neutral description of a quantum gate or gate sequence that entangles two or more qubits (e.g., Hadamard+controlled-not sequence, etc.) to one or more corresponding architecture-specific operations (e.g., gates, ISA instructions, etc.) for entangling the two or more qubits. In some instances, the neutral-to-architecture mappings can include data entries correlating ranges of possible quantum operations to corresponding groups of architecture-specific operations for performing the quantum operations. As a non-limiting illustrative example, in some instances, neutral-to-architecture mappings 54 can include data entries correlating a plurality of regions of a Bloch sphere to corresponding optimized groups of operations supported by a first architecture 36 for rotating a single qubit by an angle that falls within the region of the Bloch sphere. Similar region-to-operation mappings are also possible for multi-qubit quantum state spaces (e.g., state spaces including entangled quantum states), which can be represented by ranges of quantum state vectors in Hilbert space or the like. As another example, in some instances, neutral-to-architecture mappings 54 can include unitary matrix mappings 54-5 correlating ranges of unitary matrix operator values (e.g., 2×2 square unitary matrices for single-qubit operations, 4×4 square unitary matrices for two-qubit operations, 2ⁿ×2ⁿ square unitary matrices for n-qubit unitary transformations of an n-qubit quantum state, etc.) to corresponding optimized implementations (e.g., corresponding first-ISA 36-1 instructions optimized for execution on a first quantum computing architecture 36, corresponding optimized sets of quantum gates, etc.) for transforming a state of one or more qubits according to a unitary matrix operator within each range.

In some instances, an architecture-aware compiler 28 can compile an architecture-specific quantum program 14-2 into a compiled program 16-2 associated with a different architecture based on architecture-to-architecture mappings 52 or based on neutral-to-architecture mappings 54 of one or more of a source architecture associated with the quantum program 14-2 and a target architecture for the compiled program 16-2. For example, in some instances, compiling a compiled program 16-2 can include mapping, based on a first data structure comprising neutral-to-architecture mappings 54 correlating operations (e.g., ISA instructions, etc.) specific to the source architecture to architecture-neutral representations of corresponding quantum operations (e.g., unitary matrices, Dirac notation, quantum circuit diagrams, etc.), operations of the quantum program 14-2 to architecture-neutral operations; and subsequently mapping, based on a second data structure comprising neutral-to-architecture mappings 54 correlating architecture-neutral representations of corresponding quantum operations to corresponding operations specific to the target architecture (e.g., ISA instructions, etc.), the architecture-neutral operations to corresponding instructions of the compiled program 16-2.

In some instances, a mapping data structure 48 can include intent-to-architecture mappings 56, along with corresponding architecture-to-intent and neutral-to-intent mappings. An intent can include, for example, a target operation or target result associated with a set of quantum operations. As a non-limiting illustrative example, a quantum program 14 may include a plurality of error correction operations to correct for various error sources associated with a physical quantum computing device (e.g., qubit decoherence, leakage, crosstalk, thermal noise, etc.). The plurality of error correction operations, along with one or more other quantum computing operations, may combine to form an error-corrected target operation. In some instances, a target operation can include a single operation (e.g., ISA instruction, quantum gate), or multiple operations (e.g., plurality of quantum gates that combine to perform an error-corrected quantum operation, etc.). In such instances, an intent-to-architecture mapping 56 can map a target operation to a plurality of operations, including one or more error correction operations. Similarly, an architecture-to-intent mapping can map a plurality of operations of a quantum program 14 to an inferred target operation. For example, an architecture-to-intent mapping data structure can include one or more data entries correlating architecture-specific programming patterns (e.g., error correction programming patterns that may be standard or common in a particular architecture 36, 38, etc.; common programming patterns for performing higher-level operations by combining lower-level operations of a particular architecture 36, 38, etc.; or other groups of quantum computing operations that compose a higher-level operation) to corresponding target operations.

In some instances, architecture-to-architecture mappings 52 can include “intent-to-intent” mappings (e.g., like-for-like mappings of higher-level target operations), which can correlate a plurality of programming patterns (e.g., groups of operations) associated with a first quantum computing architecture 36 to a plurality of corresponding programming patterns of a second quantum computing architecture 38 for performing similar (e.g., same) target operations. As a non-limiting illustrative example, a first architecture 36 may include a qubit grid configured to perform surface code error correction, and a second architecture 38 may include hardware configured to perform another form of error correction (e.g., repetition code, etc.). In some instances, a first instruction set architecture 36-1 or second instruction set architecture may require a plurality of instructions of the instruction set architecture to be called (e.g., by a compiler, by a quantum programmer, etc.) to perform each error correction cycle. In other instances, a first ISA 36-1 or second ISA may require one instruction for each error correction cycle, or may not require any separate instructions for performing error correction, which may happen automatically in conjunction with all first-architecture 36 operations in some instances. Continuing the non-limiting illustrative example, an architecture-to-architecture mapping 52 can include data entries correlating one or more error-corrected target operations (e.g., programming patterns, error correction instructions, etc.) of a first instruction set architecture 36-1 to one or more corresponding instructions associated with a second quantum computing architecture 38 for performing the same error-corrected target operation on a second-architecture quantum computer 34. In some instances, architecture-to-architecture mappings 52 of higher-level target operations can include optimized intent-to-intent mappings, wherein the corresponding second-architecture instructions comprise one or more optimized instructions (e.g., optimized to minimize runtime, minimize a number of hardware components used, minimize a circuit depth, maximize a computational accuracy, etc.).

In some instances, an architecture-aware compiler 28 can map from an architecture-specific quantum program 14-2 to a compiled program 16 (e.g., second-architecture instructions 16-2) associated with a different quantum computing architecture by mapping one or more instructions of the quantum program 14 to one or more “intents” or target operations (e.g., higher-level target operations achieved by combining a plurality of lower-level instructions of the quantum program 14, etc.) using a first set of intent-to-architecture mappings 56, and subsequently mapping the target operations to one or more corresponding instructions of a first instruction set architecture 36-1 for performing the target operations using a second set of intent-to-architecture mappings 56. Similarly, in some instances, an architecture-aware compiler can map from an architecture-neutral quantum program 14-1 to a compiled program 16 associated with a particular architecture by identifying one or more target operations (e.g., individual unitary matrix operators; higher-level target operations comprising a plurality of quantum gates depicted in a quantum circuit diagram; etc.) of the architecture-neutral quantum program 14-1 and mapping the target operations to one or more corresponding instructions of a first instruction set architecture 36-1 for performing the target operations (e.g., instructions for performing error-corrected versions of the target operations; optimized sets of instructions for performing the target operations; etc.) based on one or more intent-to-architecture mappings 56.

In some instances, compiling a compiled program 16 based on a quantum program 14 can include splitting the quantum program 14 into subprograms and mapping operations of one or more of the subprograms to corresponding instructions of a target quantum computing architecture 36, 38. Splitting can be performed in various ways, such as splitting by time step; splitting by qubit groups; splitting based on a fixed quantum circuit size (e.g., number of qubits, circuit depth, etc.); splitting based on one or more patterns identified by a computing device 12 (e.g., programming patterns associated with known operations in a data structure storing architecture-to-intent mappings, etc.); or other method. For example, in some instances, compiling a compiled program 16 based on a quantum program 14 can include identifying (e.g., based on one or more mapping data structures 48) one or more groups of interrelated operations in the quantum program 14 (e.g., programming patterns such as error-correction programming patterns, higher-level target operations, etc.), and mapping each identified group to one or more corresponding instructions of a target instruction set architecture (e.g., based on an architecture-to-architecture mapping 52, neutral-to-architecture mapping 54, optimization mapping 58, etc.). In instances where a quantum program 14 may comprise one or more operations that do not belong to any of the identified groups, then compiling a compiled program 16 can further include separately mapping each remaining operation to one or more instructions of a target architecture. For example, in some instances, an architecture-aware compiler can perform a first mapping pass that maps as many operations (e.g., higher-level target operations associated with a programmer intent, etc.) of the quantum program 14 as possible to one or more corresponding optimized instructions of a target quantum computing architecture 36, 38, and then performs a second pass to map the remaining operations of the quantum program 14 based on a naive gate-to-gate or ISA-to-ISA mapping 52-1, 52-2, which may map each remaining gate or ISA instruction to one or more instructions of a target quantum computing architecture 36, 38 (e.g., without regard to optimization, etc.).

In some instances, a mapping data structure 48 can include language-to-architecture mappings 60, which can include mappings related to architecture-specific quantum programming languages and architecture-agnostic quantum programming languages. In some instances, language-to-architecture mappings 60 can have any property described above with respect to other mappings. For example, a language-to-architecture mapping can include gate-to-gate mappings, language-command-to-gate mappings, language-command-to-ISA-instruction mappings, language-command(s)-to-intent mappings, optimization mappings, neutral-to-architecture mappings (e.g., if a language is architecture-agnostic or includes architecture-agnostic components), architecture-to-architecture mappings (e.g., if a language is architecture-specific or includes architecture-specific components), or the like. Mapping based on language-to-architecture mappings can include using any system or performing any activity described above with respect to other mappings.

In some instances, a computing system 10 can compile a compiled program 16 use one or more machine-learned models 50. For example, in some instances, a machine-learned model 50 (e.g., transformer, etc.) can be trained to receive a quantum program 14 as input and generate a candidate compiled program 16 as output. For example, in some instances, the machine-learned model 50 can be trained using training data comprising a plurality of training examples, wherein each training example can include a quantum program 14 and a corresponding compiled program 16. In some instances, compiled programs 16 used to train the machine-learned model 50 can include optimized (e.g., human-optimized) compiled programs 16 configured to achieve a similar (e.g., same) final result as the input quantum program 14 at minimum or near-minimum cost (e.g., minimum circuit depth, minimum number of qubits used, etc.), maximum or near-maximum speed (e.g., minimum runtime, etc.), maximum or near-maximum accuracy (e.g., maximum error-correction accuracy, minimum noise, maximum gate fidelity, etc.), or the like.

In some instances, compiling a compiled program can include checking a candidate compiled program to ensure that the candidate compiled program achieves the same final result as the input quantum program 14. Checking a candidate compiled program can include, for example, simulating the candidate compiled program; performing a static analysis of the candidate compiled program; splitting the candidate compiled program and quantum program 14 into subprograms, and simulating or statically analyzing each subprogram; or the like. In some instances, compiling a compiled program 16 using a machine-learned model 50 can include editing the candidate compiled program (e.g., adding, deleting, or editing one or more instructions of the candidate compiled program, etc.) based on the checking (e.g., based on error data associated with errors identified by checking the candidate compiled program, etc.).

In some instances, a machine-learned model 50 can be further trained using feedback generated by checking or editing the candidate programs (e.g., according to a reinforcement learning training method, etc.). For example, in some instances, a reinforcement learning signal can be determined based on whether a candidate compiled program worked correctly; based on how much the candidate compiled program needed to be edited (e.g., Levenshtein edit distance, etc.); human feedback associated with the candidate compiled program; or other loss function determined based on the candidate compiled program (e.g., based on a comparison between the candidate compiled program and an edited compiled program, based on a measure of the candidate compiled program's computational performance, etc.).

In addition to an instruction set architecture 36-1, a first quantum computing architecture 36 can include various other aspects of a quantum computing architecture, such as a qubit topology 36-2, gate topology 36-3, hardware abstraction layer 36-4, hardware components or component types 36-5, and the like. As used herein, a topology (e.g., qubit topology, gate topology, etc.) can include data indicative of any aspect of a physical layout of one or more hardware components. For example, in some instances, a qubit topology 36-1 can include data indicative of one or more connections between qubits (e.g., qubit-qubit couplings, etc.), connections between qubits and other hardware components (e.g., qubit-gate couplings), absolute or relative qubit locations (e.g., physical location on a chip, logical location in an address space or the like, physical distance between neighboring qubits, physical length of a signal line between neighboring hardware components, etc.), or any other data indicative of a physical layout of one or more qubits in a quantum computing system. Similarly, a gate topology 36-2 can include data indicative of one or more connections between gates or hardware for implementing gates, physical locations of gates or hardware for implementing gates, and the like.

In some instances, an architecture-aware compiler 28 may take into account one or more architectural aspects 36-2, 36-3, 36-4, 36-5 of a first architecture 36 other than an instruction set architecture when generating a compiled program 16-1 for the first architecture 36. For example, in some instances, a mapping data structure 48 can include architecture-to-architecture or neutral-to-architecture mappings 52, 54 that may be based at least in part on the other architectural aspects 36-2, 36-3, 36-4, 36-5. For example, a plurality of quantum operations of a quantum program 14, which may be written for a different architectural having a different qubit topology 36-2 or gate topology 36-3, can be mapped to a corresponding plurality of quantum instructions of a first quantum instruction set architecture 36-1, wherein the mapped instructions achieve a result that is mathematically equivalent to a result of the quantum program 14 when the mapped instructions are executed by a first-architecture quantum computer 32. As another example, a plurality of quantum operations of a quantum program 14 designed to be executed using one type of hardware component can be mapped to a corresponding plurality of quantum operations to be performed using a different type of hardware component 36-5 of the first quantum computing architecture 36. In some instances, the mapped instructions can be mathematically equivalent to the operations of the quantum program 14 when executed by a first-architecture quantum computer 32. In some instances, such mapping can be performed in any manner described above (e.g., based on a mapping data structure 48; using a machine-learned model 50; etc.).

In some instances, a compiled program can include an optimized compilation 40, which can include one or more optimized instructions or group of instructions, such as an optimized routing 40-1 or one or more optimized gate controls 40-2. For example, an optimized routing 40-1 can include a routing of a signal or other data (e.g., quantum state, etc.) between one or more quantum hardware components (e.g., qubits, quantum gates, hardware for implementing qubits or quantum gates, etc.) of a quantum computing system. In some instances, an optimized routing can include a routing configured to perform a target operation or achieve a target result (e.g., delivering a signal to a target destination, etc.) in an optimized way (e.g., minimized transmission distance, maximized fidelity, minimized transmission time, minimized usage of hardware components, etc.). An optimized gate control 40-2 can include, for example, one or more control operations (e.g., ISA instructions, control signals, control pulse shapes, etc.) configured to execute a quantum gate in an optimized way (e.g., minimum number of ISA instructions, minimum gating time, maximum gate fidelity, etc.).

In some instances, generating an optimized compilation 40 can include mapping operations of a quantum program 14 to corresponding optimized operations associated with a target quantum computing architecture 36, 38. Mapping can include, for example, any mapping method described above, such as mapping using a machine-learned model 50 or mapping based on a data structure correlating operations of a quantum program 14 to corresponding optimized operations. For example, in some instances, a machine-learned model 50 (e.g., transformer, etc.) can be trained using a plurality of training examples, wherein each training example comprises a quantum program 14 and a corresponding optimized compilation 40 of the target quantum computing architecture 36, 38. In such instances, the trained machine-learned model can be provided with a new quantum program 14, and the machine-learned model 50 can generate a candidate compiled program based on the quantum program 14. In some instances, the candidate compiled program can be checked for accuracy (e.g., accuracy of the final result, optimization accuracy, etc.) and corrected if necessary before being output as a final optimized compilation 40. For example, in some instances, a candidate optimized compilation can be checked by an optimization algorithm (e.g., heuristic algorithm, evolutionary algorithm, etc.) to determine whether the candidate optimized algorithm can be further optimized (e.g., based on one or more mapping data structure 48). For example, in some instances, a candidate optimized compilation can be checked using a local optimization algorithm (e.g., hill climbing algorithm, etc.) to determine whether the candidate optimized compilation comprises a locally optimal compiled program 16 (e.g., local optimum of an algorithm search space, etc.) for achieving a target result associated with the quantum program 14. For example, a heuristic algorithm can analyze subcomponents (e.g., two-gate combinations, n-gate combinations, etc.) of a candidate optimized compilation and determine, for each subcomponent, whether the subcomponent can be swapped with a more optimal (e.g., faster, lower hardware usage, higher fidelity, etc.) set of operations to achieve the same result.

In some instances, generating an optimized compilation 40 can include mapping operations based on a data structure comprising optimization mappings 58. Optimization mappings 58 can include, for example, instruction-level optimization mappings 58-1, gate-level optimization mappings 58-2, routing optimization mappings 58-3, or other optimization mappings. Instruction-level optimization mappings 58-1 can include, for example, data entries correlating one or more operations of a quantum program 14 to a corresponding optimized set of ISA instructions for performing the one or more operations or equivalent operations. An optimized set of ISA instructions can include, for example, a set having a minimum or near-minimum number of instructions; a set of instructions for performing a quantum operation using a minimum or near-minimum number of qubits or other hardware components; a set of instructions for performing a quantum operation with maximum or near-maximum accuracy (e.g. gate fidelity, etc.); or the like. Gate-level optimization mappings 58-2 can include, for example, data entries correlating one or more operations of a quantum program 14 to a corresponding optimized set of quantum gates or gate controls (e.g., control pulse shapes, etc.) for performing the operations at minimum cost, maximum accuracy, or the like. In some instances, mapping operations of a quantum program 14 to corresponding optimized ISA instructions or gate controls 40-2 can include any activity described above with respect to mapping based on a mapping data structure 48.

Routing optimization mappings 58-3 can include, for example, data entries correlating operations of a quantum program 14 to one or more optimized routings for performing the operations. A routing can include, for example, a routing of a physical or logical signal, such as a routing of quantum data (e.g., one or more quantum states associated with one or more logical qubits) between quantum hardware components (e.g., hardware components for implementing qubits, quantum gates, or the like); routing of a control signal, such as an oscillating or steady-state voltage signal, current signal, magnetic flux signal, or the like; or other routing operation. In some instances, an optimized routing can include a routing that has been optimized based on a qubit topology 36-2 or gate topology 36-3 of the first quantum computing architecture 36.

In some instances, a compiled program 16 can include an operating-system-aware (OS-aware) compilation 42. For example, in some instances, an OS-aware compilation 42 can include one or more operating system commands 42-2 for interacting with a quantum operating system executing on a first-architecture quantum computer 32, along with other components, such as ISA instructions 42-1 associated with a first quantum instruction set architecture 36-1. As used herein, a quantum operating system can include any quantum control firmware or software configured to manage hardware resources for executing one or more quantum programs 14, 16 on one or more quantum computers 32, 34. For example, a quantum operating system can include one or more software or firmware components for allocating hardware components (e.g., qubits, etc.) to one or more compiled programs 16; scheduling execution of one or more ISA instructions of a compiled program 16; interfacing between a compiled program 16 and one or more hardware components (e.g., by providing ISA instructions to the hardware components; by providing control signals to the hardware components based on one or more ISA instructions; etc.); or performing other quantum operating system functions. In some instances, generating an OS-aware compilation can include, for example, mapping operations of a quantum program 14 to one or more corresponding operating system commands 42-2 according to one or more methods described above (e.g., using a machine-learned model 50; using a data structure comprising quantum-program-to-operating-system mappings 62 according to methods described above; etc.).

In some instances, a computing device 12 can perform constraint checking to check whether a quantum program 14 is compatible with a particular quantum operating system, quantum computing architecture 36, 38, or quantum computing device 32, 34; whether the quantum program 14 is compatible with a particular quantum computing architecture 36, 38; whether a quantum operating system is compatible with a particular quantum computing device 32, 34; or the like.

For example, in some instances, a computing device can obtain data 45, 47 describing one or more quantum operating systems 44, 46. The data 45, 47 can include, for example, data indicative of one or more quantum architecture constraints 45-1 of the quantum operating system 44, 46. An architecture constraint 45-1 can include, for example, one or more architectural compatibility constraints that a quantum computing architecture 36, 38 must meet to be compatible with a quantum operating system 44, 46. For example, some quantum operating systems may only be compatible with specific qubit topologies or gate topologies; specific instruction set architectures; specific hardware component types or hardware abstraction layers; or the like. In such instances, a computing device 12 can compare architectural constraint 45-1 data to architecture data 37, 39 to determine whether a particular quantum computing architecture 36, 38 satisfies the architectural constraints 45-1 of a particular quantum operating system 44, 46.

As another example, a computing device 12 can compare operating system feature data 45-2 of a quantum operating system 44 to operating system constraint data 68 associated with a quantum program 14 (e.g., operating system feature requirement data indicating one or more operating system features a quantum program 14 requires to run, etc.) to determine whether the quantum program 14 is compatible with the quantum operating system 44. Similarly, a computing device 12 can compare architecture data 37, 39 indicative of a quantum computing architecture 36, 38 to one or more architectural constraints 70 of a quantum program 14 to determine whether the quantum program 14 is compatible with the quantum computing architecture(s) 36, 38.

Additionally, in some instances, a computing device 12 can determine one or more device-specific constraints of a quantum program 14 or compiled program 16 (e.g., minimum number of qubits accessed, hardware components used, etc.), and may compare the device-specific constraints to device-specific data 72 to determine whether a quantum program 14 or compiled program 16 is compatible with a particular device. For example, in some instances, a computing device 12 can generate, based on a quantum program 14, a compiled program 16; determine, based on the compiled program 16, a minimum number of hardware components (e.g., qubits, etc.) of a particular type needed to execute the compiled program 16; compare the minimum number to hardware count data 74-1 associated with a particular quantum computing device 32-1; and determine, based on the comparison, whether the compiled program 16 can be executed on the quantum computing device. In some instances, if the compiled program 16 is not compatible, the computing device 12 can attempt recompilation based on the comparison. As a non-limiting illustrative example, if a computing device 12 optimizes a compiled program 16 to minimize a runtime or circuit depth of the compiled program 16, and subsequently determines that the compiled program 16 would use more qubits than are available on a particular quantum computing device 32-1, the computing device 12 can generate a new compiled program 16 that is optimized to minimize a qubit count. In some instances, the computing device 12 can subsequently check, based on a comparison to hardware count data 74-1, whether a new compiled program 16 can be executed on the quantum computing device 32-1. In some instances, the computing device 12 can optimize a compiled program 16 based on more than one constraint of the compiled program, such as by optimizing a target first variable (e.g., runtime, circuit depth, fidelity, etc.) subject to satisfying a constraint associated with a second variable (e.g., satisfying a threshold associated with a qubit count, such as a maximum number of qubits that can be allocated at any one time, etc.).

In some instances, a computing device 12 can generate a compiled program 16 based at least in part on various kinds of device-specific data 72. For example, in some instances, a particular quantum computing architecture 36, 38 may support multiple hardware component topologies 74-3 (e.g., instead of or in addition to having one or more topologies 36-2, 36-3 that are shared by a plurality of quantum computers that share an architecture 36, 38), multiple sets of hardware component types 74-2, or other properties of an individual quantum computer 32, 34. In such instances, a computing device 12 can generate a compiled program 16 based on device-specific data 72 according to any manner described above with respect to compiling based on architecture-specific data, such as by mapping operations of a quantum program 14 to corresponding operations of a compiled program 16 based on device-specific mappings, such as device-specific routing optimizations based on a device-specific hardware topology 74-3; device-specific intent-to-device mappings based on data indicative of available hardware components, such as hardware counts 74-1 or hardware component types 74-2; or other device-specific mapping data.

In some instances, a computing device 12 can select a quantum architecture 36, 38 or quantum computing device 32, 34 to execute a quantum program 14 or compiled program 16 based on one or more performance estimates. For example, in some instances, a computing system 10 can compile a quantum program 14 based on a plurality or quantum computing architecture 36, 38 to generate a plurality of compiled programs 16 respectively associated with the plurality of architectures 36, 38; estimate, for each architecture, one or more values indicative of a performance of one or more quantum computing devices 32, 34 executing a corresponding compiled program 16; and determine, based on the estimates, a preferred architecture for executing the quantum program 14. Example values indicative of computing performance can include computational accuracy (e.g., quantum fidelity, etc.), runtime, circuit depth, number of qubits used to execute the compiled program, computational cost (e.g., electricity cost, hardware usage cost, etc.) of executing the program, or other value indicative of computing performance. Determining a preferred architecture can include, for example, comparing a first estimated value associated with a first architecture to a second estimated value associated with a second architecture (e.g., selecting the architecture with the highest computational accuracy, lowest cost, etc.); determining, based on an architecture selection rule set and based on a plurality of estimated values, a preferred architecture; determining, based on a formula (e.g., mathematical formula) that takes a plurality of estimated values as input, a preferred architecture; or the like.

Similarly, a computing system 10 can determine a preferred quantum computing device 32-1, 32-2, 34-1, 34-2 for executing a compiled program 16 or quantum program 14 by estimating a performance of the compiled program 16 on two or more devices, and selecting a preferred device based on the estimates. For example, a computing system 10 can determine a preferred architecture for executing a quantum program 14; and subsequently determine a preferred quantum computing device 32, 34 of the selected architecture for executing a compiled program 16 generated based on the quantum program 14, wherein the compiled program 16 is compiled for execution on the selected architecture.

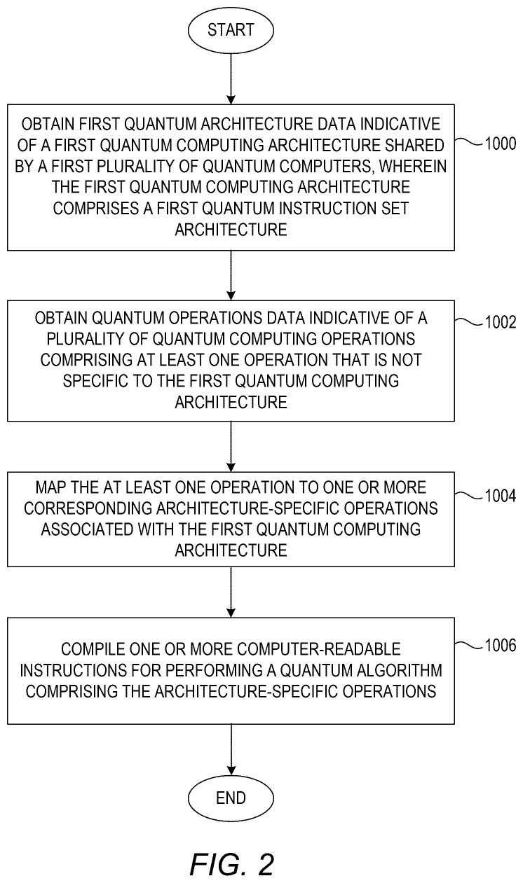

FIG. 2 is a flowchart diagram of a method for compiling a quantum computing program to a first quantum architecture. The method of FIG. 2 can be performed, for example, by a computing system 10.

At 1000, a computing system 10 can obtain (e.g., receive, retrieve, generate, etc.) first quantum architecture data (e.g., first architecture data 37) indicative of a first quantum computing architecture (e.g., first quantum computing architecture 36) shared by a first plurality of quantum computers (e.g., first-architecture quantum computers 32), wherein the first quantum computing architecture comprises a first quantum instruction set architecture (e.g., first instruction set architecture 36-1). Obtaining first quantum architecture data can include, for example, one or more activities described above with respect to FIG. 1.

At 1002, the computing system 10 can obtain (e.g., receive from a user or computing device, retrieve from a storage device, generate, etc.) quantum operations data (e.g., quantum program 14, etc.) indicative of a plurality of quantum computing operations comprising at least one operation that is not specific to the first quantum computing architecture. Obtaining quantum operations data can include, for example, one or more activities described above with respect to FIG. 1.

At 1004, the computing system 10 can map the at least one operation to one or more corresponding architecture-specific operations (e.g., first-architecture instructions 16-1) associated with the first quantum computing architecture. Mapping the at least one operation can include, for example, one or more activities described above with respect to FIG. 1.

At 1006, the computing system can compile one or more computer-

readable instructions (e.g., first-architecture instructions 16-1) for performing a quantum algorithm comprising the architecture-specific operations. Compiling the computer-readable instructions can include, for example, one or more activities described above with respect to FIG. 1.

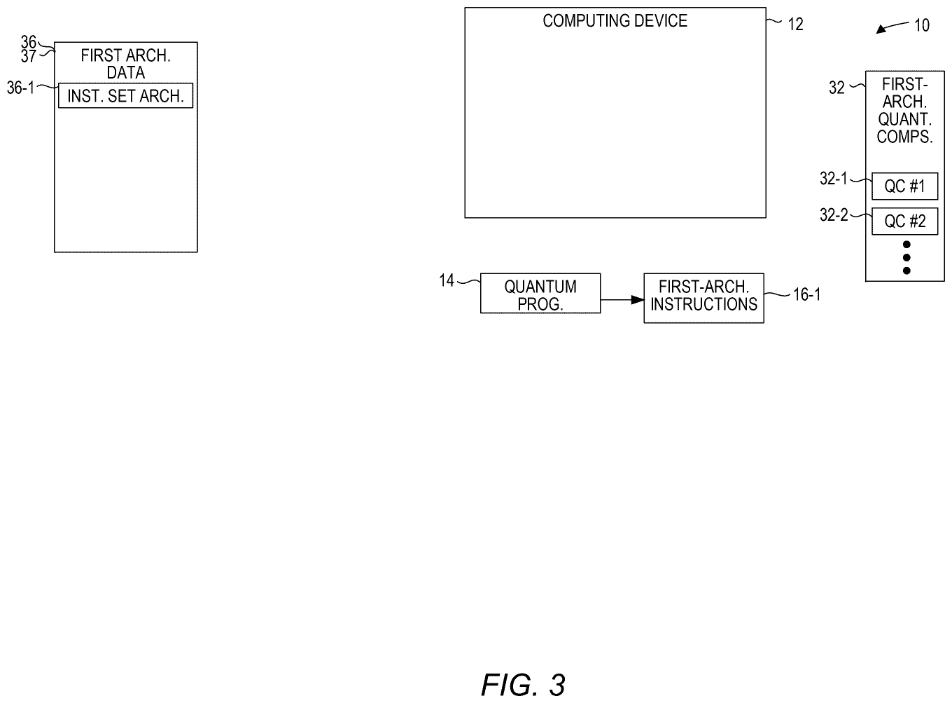

FIG. 3 is a simplified block diagram of the environment illustrated in FIG. 1 according to one implementation. A computing system 10 comprising one or more computing devices 12 can obtain first-architecture data 37 indicative of a first quantum computing architecture 36 shared by a first plurality 32 of quantum computers 32-1, 32-2, wherein the first quantum computing architecture comprises a first quantum instruction set architecture 36-1. The computing system 10 can obtain quantum operations data (e.g., a quantum program 14) indicative of a plurality of quantum computing operations, wherein the quantum computing operations comprise at least one operation that is not specific to the first quantum computing architecture 36. The computing system 10 can map the at least one operation to one or more corresponding architecture-specific operations associated with the first quantum computing architecture, and can compile, based at least in part on the mapping, one or more computer-readable instructions 16-1 for performing a quantum algorithm comprising the one or more corresponding architecture-specific operations.

In some implementations, the parts depicted in FIG. 3 can be, comprise, be comprised by, share similar (e.g., same) properties or operate in a manner similar to (e.g., same as) one or more examples set forth in the description of FIG. 1 with respect to parts sharing a similar (e.g., same) name and part number.

FIG. 4 is a block diagram of the computing device 430 suitable for implementing examples according to one example. The computing device 430 may comprise any computing or electronic device capable of including firmware, hardware, and/or executing software instructions to implement the functionality described herein, such as a computer server, a desktop computing device, a laptop computing device, a smartphone, a computing tablet, or the like. The computing device 430 includes the processor device 432, the system memory 450, and a system bus 446. The system bus 446 provides an interface for system components including, but not limited to, the system memory 450 and the processor device 432. The processor device 432 can be any commercially available or proprietary processor.

The system bus 446 may be any of several types of bus structures that may further interconnect to a memory bus (with or without a memory controller), a peripheral bus, and/or a local bus using any of a variety of commercially available bus architectures. The system memory 450 may include non-volatile memory 452 (e.g., read-only memory (ROM), erasable programmable read-only memory (EPROM), electrically erasable programmable read-only memory (EEPROM), etc.), and volatile memory 454 (e.g., random-access memory (RAM)). A basic input/output system (BIOS) 470 may be stored in the non-volatile memory 452 and can include the basic routines that help to transfer information between elements within the computing device 430. The volatile memory 454 may also include a high-speed RAM, such as static RAM, for caching data.

The computing device 430 may further include or be coupled to a non-transitory computer-readable storage medium such as the storage device 464, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 464 and other drives associated with computer-readable media and computer-usable media may provide non-volatile storage of data, data structures, computer-executable instructions, and the like.

A number of modules can be stored in the storage device 464 and in the volatile memory 454, including an operating system 456 and one or more program modules, such as the cross-architectural compiler module 466, which may implement the functionality described herein in whole or in part. All or a portion of the examples may be implemented as a computer program product 458 stored on a transitory or non-transitory computer-usable or computer-readable storage medium, such as the storage device 464, which includes complex programming instructions, such as complex computer-readable program code, to cause the processor device 432 to carry out the steps described herein. Thus, the computer-readable program code can comprise software instructions for implementing the functionality of the examples described herein when executed on the processor device 432. The processor device 432, in conjunction with the cross-architectural compiler module 466 in the volatile memory 454, may serve as a controller, or control system, for the computing device 430 that is to implement the functionality described herein.

An operator, such as a user, may also be able to enter one or more configuration commands through a keyboard (not illustrated), a pointing device such as a mouse (not illustrated), or a touch-sensitive surface such as a display device. Such input devices may be connected to the processor device 432 through an input device interface 460 that is coupled to the system bus 446 but can be connected by other interfaces such as a parallel port, an Institute of Electrical and Electronic Engineers (IEEE) 1394 serial port, a Universal Serial Bus (USB) port, an IR interface, and the like. The computing device 430 may also include the communications interface 462 suitable for communicating with a network (e.g., the internet) as appropriate or desired. The computing device 430 may also include a video port configured to interface with a display device, to provide information to a user.

Individuals will recognize improvements and modifications to the preferred examples of the disclosure. All such improvements and modifications are considered within the scope of the concepts disclosed herein and the claims that follow.

What is claimed is:

1. A method, comprising:
obtaining, by a computing system comprising one or more computing devices, first quantum architecture data indicative of a first quantum computing architecture shared by a first plurality of quantum computers, wherein the first quantum computing architecture comprises a first quantum instruction set architecture;
obtaining, by the computing system, quantum operations data indicative of a plurality of quantum computing operations, wherein the quantum computing operations comprise at least one operation that is not specific to the first quantum computing architecture;
mapping, by the computing system based on the first quantum architecture data, the at least one operation to one or more corresponding architecture-specific operations associated with the first quantum computing architecture; and
compiling, by the computing system based at least in part on the mapping, one or more computer-readable instructions for performing a quantum algorithm comprising the one or more corresponding architecture-specific operations.

2. The method of claim 1, further comprising:
obtaining, by the computing system, second quantum architecture data indicative of a second quantum computing architecture shared by a second plurality of quantum computers, wherein the second quantum computing architecture comprises a second quantum instruction set architecture, and wherein the at least one operation is not specific to the second quantum computing architecture;
mapping, by the computing system based on the second quantum architecture data, the at least one operation to one or more corresponding second-architecture-specific operations associated with the second quantum computing architecture; and
compiling, by the computing system based at least in part on the mapping, one or more computer-readable instructions for performing a quantum algorithm comprising the one or more corresponding second-architecture-specific operations.

3. The method of claim 1, wherein the at least one operation is specific to one or more second quantum computing architectures that are different from the first quantum computing architecture, and mapping comprises:
accessing, by the computing system, a data structure correlating a plurality of operations specific to the second quantum computing architecture to a plurality of corresponding operations that are compatible with the first quantum computing architecture;
retrieving, by the computing system from the data structure, a data entry correlating the at least one operation to a set of one or more corresponding operations that are compatible with the first quantum computing architecture; and
including, by the computing system, the one or more corresponding operations in the one or more computer-readable instructions.

4. The method of claim 3, wherein:
the at least one operation is a single instruction of a second quantum instruction set architecture of the second quantum computing architecture;
the set of one or more corresponding operations comprises a plurality of instructions of the first quantum instruction set architecture; and
the plurality of instructions, when performed together, are equivalent to the single instruction of the second quantum instruction set architecture.

5. The method of claim 4, wherein the single instruction comprises an error-corrected quantum operation, and the plurality of instructions comprise one or more error correction operations.

6. The method of claim 4, wherein the single instruction comprises a single quantum gate, and the plurality of instructions comprises a plurality of quantum gates that, when performed together, are equivalent to the single quantum gate.

7. The method of claim 1, wherein the at least one operation is an architecture-agnostic quantum computing operation, and mapping comprises:
accessing, by the computing system, a data structure correlating a plurality of architecture-agnostic quantum computing operations to a plurality of corresponding instructions of the first quantum instruction set architecture;
retrieving, by the computing system from the data structure, a data entry correlating the at least one operation to a set of one or more corresponding instructions of the first quantum instruction set architecture; and
including, by the computing system, the one or more corresponding instructions in the one or more computer-readable instructions.

8. The method of claim 7, wherein the data structure is a data structure correlating a plurality of architecture-agnostic operations to a plurality of corresponding optimized implementations of architecture-agnostic operations, wherein the optimized implementations are optimized for execution on the first quantum computing architecture.

9. The method of claim 1, wherein the first quantum computing architecture comprises at least one of a qubit topology and a gate topology, and further comprising:
mapping, based at least in part on the at least one topology, one or more operations of the quantum computing operations to an optimized routing of a quantum computing signal, wherein the optimized routing is optimized for the first quantum computing architecture.

10. The method of claim 1, wherein the at least one operation comprises a unitary transformation of a quantum state of one or more qubits, and mapping comprises:
accessing, by the computing system, a data structure correlating a plurality of n-qubit unitary transformations to a plurality of corresponding optimized sets of quantum gates for performing the n-qubit unitary transformations, wherein the optimized sets of quantum gates are optimized for the first quantum computing architecture;
retrieving, by the computing system from the data structure, a data entry correlating the at least one operation to a corresponding optimized set of quantum gates; and
including, by the computing system in the one or more computer-readable instructions, one or more instructions of the first quantum instruction set architecture to implement the corresponding optimized set of quantum gates.

11. The method of claim 10, wherein the unitary transformation comprises a multi-qubit quantum gating operation to entangle two or more qubits.

12. The method of claim 1, further comprising:
obtaining, by the computing system, second quantum architecture data indicative of a second quantum computing architecture shared by a second plurality of quantum computers;
identifying, by the computing system, one or more quantum architecture constraints associated with the plurality of quantum computing operations; and
determining, by the computing system based on a comparison between the second quantum computing architecture and the quantum architecture constraints, whether the plurality of quantum computing operations is compatible with the second quantum computing architecture.

13. The method of claim 1, wherein the quantum algorithm is a first quantum algorithm, and further comprising:
compiling, by the computing system, a second quantum algorithm for performing the plurality of quantum computing operations on a second quantum computing architecture;
estimating, by the computing system, a performance of the second quantum algorithm executing on the second quantum computing architecture;
estimating, by the computing system, a performance of the first quantum algorithm executing on the first quantum computing architecture; and
selecting, by the computing system based on the estimating, a preferred quantum computing architecture for performing the plurality of quantum computing operations.

14. The method of claim 1, further comprising:
obtaining, by the computing system, operating system constraint data indicative of one or more architectural compatibility constraints of a quantum operating system; and
determining, by the computing system based on the operating system constraint data, whether the quantum operating system is compatible with the first quantum computing architecture.

15. The method of claim 1, further comprising:
obtaining, by the computing system, operating system feature data indicative of one or more features of a quantum operating system that is compatible with the first quantum computing architecture;
obtaining, by the computing system, feature requirement data indicative of one or more operating system features required to perform the plurality of quantum computing operations; and
determining, by the computing system based on the operating system feature data and the feature requirement data, whether the quantum operating system is compatible with the plurality of quantum computing operations.

16. The method of claim 1, further comprising:
obtaining, by the computing system, quantum operating system data indicative of a quantum operating system that is compatible with the first quantum computing architecture;
accessing, by the computing system, a data structure correlating one or more quantum operations to one or more operating system commands of the quantum operating system;
mapping, based on the data structure, an operation of the plurality of quantum computing operations to a corresponding operating system command of the quantum operating system; and
compiling, by the computing system based at least in part on the mapping, one or more computer-readable instructions for executing a quantum computing program using the corresponding operating system command.

17. The method of claim 1, further comprising:
executing, by a quantum computing device having the first quantum computing architecture, the quantum algorithm.

18. The method of claim 1, further comprising:
obtaining, by the computing system, device-specific data indicative of a plurality of hardware components of a quantum computing device implementing the first quantum computing architecture;
mapping, by the computing system based at least in part on the device-specific data, an operation of the plurality of quantum computing operations to one or more hardware components of the plurality of hardware components for performing the operation; and
including, in the one or more computer-readable instructions, at least one instruction to cause the one or more hardware components to perform the operation.

19. A computing system comprising:
one or more computing devices to:
obtain first quantum architecture data indicative of a first quantum computing architecture shared by a first plurality of quantum computers, wherein the first quantum computing architecture comprises a first quantum instruction set architecture;
obtain quantum operations data indicative of a plurality of quantum computing operations, wherein the quantum computing operations comprise at least one operation that is not specific to the first quantum computing architecture;
map, based on the first quantum architecture data, the at least one operation to one or more corresponding architecture-specific operations associated with the first quantum computing architecture; and
compile, based at least in part on the mapping, one or more computer-readable instructions for performing a quantum algorithm comprising the one or more corresponding architecture-specific operations.

20. A non-transitory computer-readable storage medium that includes executable instructions to cause one or more processor devices to:
obtain first quantum architecture data indicative of a first quantum computing architecture shared by a first plurality of quantum computers, wherein the first quantum computing architecture comprises a first quantum instruction set architecture;
obtain quantum operations data indicative of a plurality of quantum computing operations, wherein the quantum computing operations comprise at least one operation that is not specific to the first quantum computing architecture;
map, based on the first quantum architecture data, the at least one operation to one or more corresponding architecture-specific operations associated with the first quantum computing architecture; and
compile, based at least in part on the mapping, one or more computer-readable instructions for performing a quantum algorithm comprising the one or more corresponding architecture-specific operations.
